(19) United States
(12) Patent Application Publication
(10) Pub. No.: US 2026/0338607 A1
(43) Pub. Date: Oct. 29, 2026

(54) MARKER

(71) Applicant: NTT, Inc., Tokyo (JP)

(72) Inventors: Yasue KISHINO, Tokyo (JP); Yoshinari SHIRAI, Tokyo (JP); Shin MIZUTANI, Tokyo (JP); Kazuya OHARA, Tokyo (JP)

(73) Assignee: NTT, Inc., Tokyo (JP)

(21) Appl. No.: 19/115,213

(22) PCT Filed: Sep. 29, 2022
(86) PCT No.: PCT/JP2022/036352

§ 371 Date: Mar. 25, 2025

(51) Int. Cl. G01J 5/48; G01J 5/00

(52) U.S. Cl. CPC G01J 5/48; G01J 2005/0077

(57) ABSTRACT

A marker is a marker to be imaged by a thermal camera, in which: the marker is made from a highly thermally conductive material; a surface of the marker has a pattern by a first surface area SA1 and a second surface area SA2; and the second surface area SA2 has a higher emissivity than the first surface area SA1.

### TECHNICAL FIELD

The disclosed technology relates to a technology of achieving a marker that can be imaged by a thermal camera without a power supply.

### BACKGROUND ART

As a marker with no power supply, which can be imaged by a thermal camera, there is a marker disclosed in Non Patent Literature 1. The marker of Non Patent Literature 1 is such that a two-dimensional pattern made from an aluminum foil with a foam film is attached to the back side of clothing. When the clothing is worn on a human body and is imaged by a thermal camera, an area where the aluminum foil with the foam film is present on the back side blocks heat radiated by the human body, and thus a temperature close to an ambient temperature is imaged, whereas an area where the aluminum foil with the foam film is not present on the back side does not block the heat radiated by the human body, and thus a temperature close to a body temperature is imaged. Thus, the two-dimensional pattern can be imaged by the thermal camera.

### CITATION LIST

### Patent Literature

Patent Literature 1: Itaru Kitahara, and four others, “Thermal-ID: A Personal Identification Method Using Body Temperature”, [online], 2005, [searched on Aug. 2, 2022], Internet <URL:http://www.interaction-ipsj.org/archives/paper2005/pdf2005/interactive/A114.pdf>

### SUMMARY OF INVENTION

### Technical Problem

In Non Patent Literature 1, a marker that can be imaged by a thermal camera is achieved without a power supply. However, there is a problem that a pattern cannot be imaged unless the marker is in contact with an object whose temperature is different from an ambient temperature, such as a human body, at the time of imaging. Further, there is also a problem that, even if the marker is in contact with the object whose temperature is different from the ambient temperature at the time of imaging, in a case where a temperature unevenness of a surface of the contacted object is large, accuracy of imaging the pattern is reduced.

An object of the disclosed technology is to provide a marker whose pattern can be imaged even in a case where the marker is not in contact with an object whose temperature is different from an ambient temperature at the time of imaging and whose accuracy of imaging the pattern is not significantly reduced even in a case where a temperature unevenness of a surface of the contacted object is large at the time of imaging.

### Solution to Problem

One aspect of the disclosed technology is a marker to be imaged by a thermal camera, in which: a surface of the marker has a pattern by a first surface area and a second surface area; the second surface area has a higher emissivity than the first surface area; and the marker is made from a highly thermally conductive material.

### Advantageous Effects of Invention

According to the disclosed technology, it is possible to image a pattern even in a case where a marker is not in contact with an object whose temperature is different from an ambient temperature at the time of imaging, and accuracy of imaging the pattern is not significantly reduced even in a case where a temperature unevenness of a surface of the contacted object is large at the time of imaging.

### BRIEF DESCRIPTION OF DRAWINGS

FIG. 1A is a plan view of an example of a marker. FIG. 1B is a cross-sectional view taken along line α-α of the marker in FIG. 1A.

FIG. 2A is a plan view of an example of a marker. FIG. 2B is a cross-sectional view taken along line β-β of the marker in FIG. 2A.

FIG. 3A is a plan view of an example of a marker. FIG. 3B is a cross-sectional view taken along line γ-γ of the marker in FIG. 3A.

FIG. 4 shows an example of a functional configuration of a marker detection device 3.

FIG. 5 shows an example of a processing procedure of a marker detection method.

FIG. 6 shows an example of a functional configuration of a computer.

### DESCRIPTION OF EMBODIMENTS

Hereinafter, embodiments of the disclosed technology will be described with reference to the drawings. Note that, in the drawings, components having the same functions are denoted by the same reference signs, and redundant description will be omitted.

### Configuration of Marker

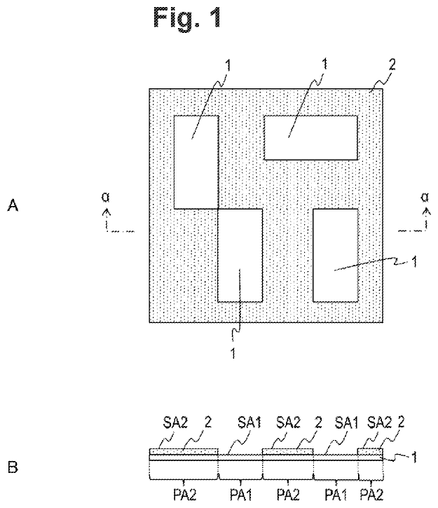

FIGS. 1A and 1B show an example of a marker. FIG. 1A is a plan view of an example of the marker. FIG. 1B is a cross-sectional view taken along line α-α of the marker in FIG. 1A.

The marker includes a first material 1 and a second material 2.

The marker is made from a highly thermally conductive material. That is, both the first material 1 and the second material 2 are made from highly thermally conductive materials. Note that the highly thermally conductive material is a material having a high thermal conductivity, for example, a material having a thermal conductivity of 10 W/mK or more. The highly thermally conductive materials used for the first material 1 and the second material 2 are appropriately selected from materials having the thermal conductivity of 10 W/mK or more depending on the use and size.

The first material 1 and the second material 2 are made from highly thermally conductive materials having different emissivities. A material having a higher emissivity between the first material 1 and the second material 2 may have the emissivity of approximately 1. For example, the first material 1 has a lower emissivity than the second material 2. In other words, the second material 2 has a higher emissivity than the first material 1. In a case where the marker is formed such that the first material 1 has a lower emissivity than the second material 2, examples of the first material 1 include metals such as copper, aluminum, zinc, gold, silver, and duralumin, and examples of the second material 2 include blackbody paint, silicon nitride, and carbon graphite.

The reason why the marker is made from a highly thermally conductive material is that the marker preferably has a uniform temperature as much as possible, for example, in order to facilitate processing of detecting the marker from a thermal image obtained by warming or cooling the marker and then imaging the marker with a thermal camera as described later or in order to facilitate processing of detecting the marker from a thermal image obtained by imaging, with the thermal camera, the marker in contact with an object whose surface has a large temperature unevenness. In order to make the marker have a uniform temperature in a short time, for example, the first material 1 and the second material 2 are preferably made from highly thermally conductive materials of 100 W/mK or more. Further, in order to make the marker have a uniform temperature even with a small amount of heat, the thickness of the marker (i.e. the thickness of the first material 1 and the thickness of the second material 2) is preferably thin. Meanwhile, in order to reduce a change in temperature from warming or cooling the marker to imaging the marker with the thermal camera, the volume of the marker (i.e. the volume of the first material 1 and the volume of the second material 2) is preferably large. The first material 1 and the second material 2 of the marker preferably have a predetermined thickness and size in consideration of the above description and the like. The predetermined thickness and size are appropriately determined by experiments or the like so as to obtain desired results.

By attaching the second material 2 to a partial area of one surface of the plate-shaped first material 1 serving as a base material, a pattern is formed on a surface of the marker by an area where the surface of the first material 1 is exposed and an area where a surface of the second material 2 is exposed. An example of the pattern formed on the surface of the marker is a pattern used in an AR marker. Regarding an example of the pattern used in the AR marker, see Reference Literature 1. Note that the pattern formed on the surface of the marker may be a predetermined one-dimensional barcode, a predetermined two-dimensional barcode, or the like or may be any predetermined pattern.

(Reference Literature 1) Kato, H., Billinghurst, M. “Marker tracking and hmd calibration for a video-based augmented reality conferencing system.”, In Proceedings of the 2nd IEEE and ACM International Workshop on Augmented Reality (IWAR 99), October 1999.

The marker is subjected to processing of detecting the marker from a thermal image obtained by imaging the marker with the thermal camera, and thus the pattern of the marker does not need to be visible. That is, the pattern of the marker may be made inconspicuous in a wavelength range of visible light. Therefore, the marker can be an invisible marker whose pattern is inconspicuous to human eyes. For example, the pattern can be made inconspicuous in the wavelength range of visible light by using materials having similar colors for the first material 1 and the second material 2.

Conversely, the pattern of the marker may be conspicuous in the wavelength range of visible light. That is, the luminance and/or color of the surface of the first material 1 and the surface of the second material 2 may be significantly different from each other. In this manner, a person can easily visually identify the marker, and the marker can also be used as a visible marker. In a case where the marker is also used as a visible marker, the first material 1 and the second material 2 may be made from materials having different luminances and/or colors.

As shown in FIG. 1B, the surface of the marker has a pattern by a first surface area SA1 and a second surface area SA2.

Here, as shown in FIG. 1B, a partial area of the marker whose surface is the first surface area SA1 will be referred to as a first partial area PA1, and a partial area of the marker whose surface is the second surface area SA2 will be referred to as a second partial area PA2.

When the first partial area PA1 and the second partial area PAZ are defined as described above, the following can be said.
The first material 1 is one base material continuous over the first partial area PA1 and the second partial area PA2.
In the first partial area PA1, the surface of the first material 1 is the first surface area SA1.
The second partial area PA2 includes the first material 1 and the second material 2 formed on the surface of the first material 1.
In the second partial area PA2, the surface of the second material 2 is the second surface area SA2.
The second surface area SA2 has a higher emissivity than the first surface area SA1.

### Modification Example 1 of Marker

As described above, the first material 1 and the second material 2 only need to have different emissivities, and thus a high/low relationship between the emissivity of the first material 1 and the emissivity of the second material 2 may be opposite to that in the above example.

That is, the plate-shaped first material 1 serving as the base material may be a highly thermally conductive material (e. g. blackbody paint, silicon nitride, and carbon graphite) having a higher emissivity than the second material 2, and the second material 2 may be a highly thermally conductive material (e.g. metals such as copper, aluminum, zinc, gold, silver, and duralumin) having a lower emissivity than the first material 1.

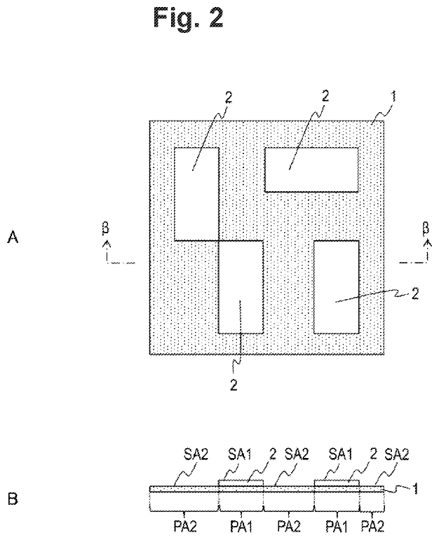

An example of the marker in this case is shown in FIGS. 2A and 2B. FIG. 2A is a plan view of an example of the marker. FIG. 2B is a cross-sectional view taken along line β-β of the marker in FIG. 2A.

As in the marker described above, by attaching the second material 2 to a partial area of one surface of the plate-shaped first material 1 serving as the base material, a pattern is formed on the surface of the marker by an area where the surface of the first material 1 is exposed and an area where the surface of the second material 2 is exposed.

As shown in FIG. 2B, the surface of the marker has a pattern by the first surface area SA1 and the second surface area SA2.

Here, as shown in FIG. 2B, a partial area of the marker whose surface is the first surface area SA1 will be referred to as the first partial area PA1, and a partial area of the marker whose surface is the second surface area SA2 will be referred to as the second partial area PA2.

When the first partial area PAL and the second partial area PA2 are defined as described above, the following can be said.
The first material 1 is one base material continuous over the first partial area PAL and the second partial area PA2.
In the second partial area PA2, the surface of the first material 1 is the second surface area SA2.
The first partial area PA1 includes the first material 1 and the second material 2 formed on the surface of the first material 1.
In the first partial area PA1, the surface of the second material 2 is the first surface area SA1.
The second surface area SA2 has a higher emissivity than the first surface area SA1.

### Modification Example 2 of Marker

The marker may be made from only the first material 1 that is one highly thermally conductive material (e.g. metals such as copper, aluminum, zinc, gold, silver, and duralumin).

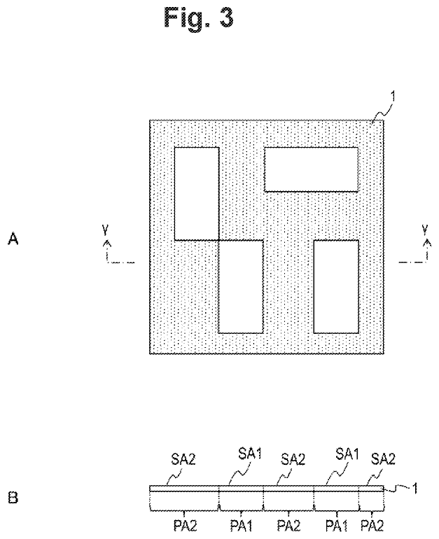

An example of the marker in this case is shown in FIGS. 3A and 3B. FIG. 3A is a plan view of an example of the marker. FIG. 3B is a cross-sectional view taken along line γ-γ of the marker in FIG. 3A.

By performing a surface treatment on a partial area of one surface of the plate-shaped first material 1 serving as the base material, a pattern is formed on the surface of the marker by an area where the surface of the first material 1 is not subjected to the surface treatment and the area where the surface of the first material 1 is subjected to the surface treatment. Alternatively, by performing a first surface treatment on a partial area of one surface of the plate-shaped first material 1 serving as the base material and performing a second surface treatment different from the first surface treatment on an area that is not the partial area of the one surface of the first material 1, a pattern is formed on the surface of the marker by the area where the surface of the first material 1 is subjected to the first surface treatment and the area where the surface of the first material 1 is subjected to the second surface treatment. The surface treatment may be a geometric treatment for changing a fine shape of the surface or a treatment for chemically changing the surface. Examples of the surface treatment include grinding such as mirror finishing, polishing, and rough polishing and oxidation.

Here, as shown in FIG. 3B, a partial area of the marker whose surface is the first surface area SA1 will be referred to as the first partial area PA1, and a partial area of the marker whose surface is the second surface area SA2 will be referred to as the second partial area PA2.

When the first partial area PAL and the second partial area PA2 are defined as described above, the following can be said.

The marker has one base material (first material 1) made from a highly thermally conductive material continuous over the first partial area PA1 and the second partial area PAZ.
Both the first surface area SA1 and the second surface area SA2 are a surface of the base material.
A surface treatment is performed on at least one of the first surface area SA1 and the second surface area SA2 such that the second surface area SA2 has a higher emissivity than the first surface area SA1. For example, the surface treatment is performed such that the second surface area SA2 is coarser than the first surface area SA1.

As described above with reference to FIGS. 1 to 3, the marker is a marker to be imaged by a thermal camera and is made from a highly thermally conductive material. The surface of the marker has a pattern by the first surface area SA1 and the second surface area SA2, and the second surface area SA2 has a higher emissivity than the first surface area SA1.

### Principle of Marker

The emissivity is a ratio obtained when the energy of light emitted from a blackbody having the same temperature as the energy of light emitted by radiation from an object of a certain temperature is set to 1. When an image is captured by the thermal camera, a temperature closer to a temperature of a surface of an object is reflected in a thermal image obtained by imaging as the emissivity is higher, and a temperature less correlated with the temperature of the surface of the object is reflected in the thermal image obtained by imaging as the emissivity is lower. For example, when the emissivity of the surface of the object is close to 1, the temperature of the surface of the object is substantially directly reflected in the thermal image. Meanwhile, when the object is imaged by the thermal camera and the emissivity is 0, an ambient temperature reflected by the surface of the object is reflected in the thermal image.

Therefore, as described in <Configuration of Marker>, for example, the marker is formed such that two types of areas having different emissivities are formed on the surface. Thus, when an image is captured by the thermal camera, a temperature closer to a temperature of the marker is reflected in a thermal image in an area having a higher emissivity between the two types of areas on the surface of the marker than in an area having a lower emissivity between the two types of areas on the surface of the marker, and a temperature closer to the ambient temperature is reflected in the thermal image in the area having the lower emissivity between the two types of areas on the surface of the marker than in the area having the higher emissivity between the two types of areas on the surface of the marker.

In a case where the temperature of the marker and the ambient temperature are close to each other, a temperature difference between the areas on the surface of the marker on the thermal image captured by the thermal camera is small between the area having the higher emissivity and the area having the lower emissivity between the two types of areas on the surface of the marker. However, in a case where a difference between the temperature of the marker and the ambient temperature is large, a difference in emissivity on the surface of the marker appears as a temperature difference between the areas on the surface of the marker on the thermal image captured by the thermal camera.

Therefore, imaging with the thermal camera is performed after the marker is warmed or cooled. For example, in a case where the marker is warmed before imaging with the thermal camera, the marker is warmed by being held, touched, or rubbed by hand for approximately two to three seconds. Further, for example, in a case where the marker is cooled before imaging with the thermal camera, the marker is cooled by the heat of vaporization by being sprayed with water by an atomizer or wiped with a wet cloth. Furthermore, for example, the marker is warmed or cooled by bringing a Peltier element into contact with a part of the marker and causing a current to flow through the Peltier element. In this manner, it is possible to image a pattern even if the marker is not in contact with an object whose temperature is different from the ambient temperature at the time of imaging.

Alternatively, imaging with the thermal camera is performed while the marker is in contact with an object whose temperature is different from the ambient temperature. In this manner, even in a case where a temperature unevenness of a surface of the contacted object is large at the time of imaging, accuracy of imaging the pattern is not significantly reduced.

Alternatively, imaging with the thermal camera is performed while a part of the marker is in contact with an object whose temperature is different from the ambient temperature. For example, the marker is imaged by the thermal camera while the Peltier element is in contact with a part of the back of the marker and a current is flowing through the Peltier element. In this manner, even in case where the object whose temperature is different from the ambient temperature is in contact with only a part of the marker at the time of imaging, the pattern can be imaged with high accuracy.

### Example of Use of Marker

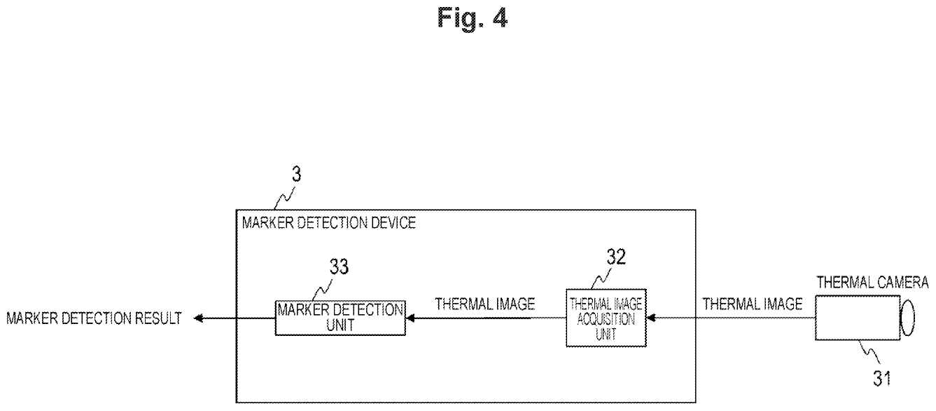

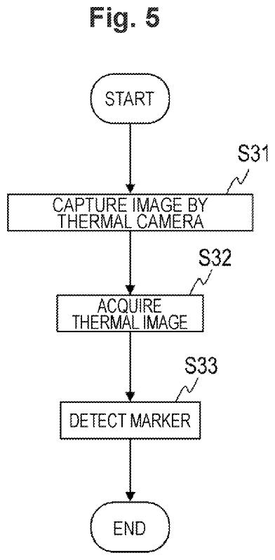

An example of use of the marker will be described with reference to FIGS. 4 and 5. In this example, the marker is detected by a marker detection device 3 and method. That is, a system including the marker having the above configuration and the marker detection device 3 is a marker detection system.

As shown in FIG. 4, the marker detection device 3 includes, for example, a thermal image acquisition unit 32 and a marker detection unit 33. The marker detection device 3 may further include a thermal camera 31.

The marker detection method is implemented by, for example, each component of the marker detection device 3 performing processing from step S31 to step S33 shown in FIG. 5.

Before processing in step S31, the marker is warmed or cooled and then is attached to a position corresponding to the use of the marker. Alternatively, before the processing in step S31, the marker is warmed or cooled while being attached to a position corresponding to the use of the marker. Alternatively, the processing in step S31 is performed while the marker is being warmed or cooled after the marker is attached to a position corresponding to the use of the marker. Examples of the way of warming and the way of cooling are as described above. The use of the marker is similar to that of a marker imaged by a conventional visible camera and is, for example, specifying an imaging range and an imaging portion or specifying a position and attitude of a camera.

### Thermal Camera 31

The thermal camera 31 captures a thermal image that is an image of heat in the imaging range including a position where the marker is attached and is an image formed by an image acquired from the thermal camera 31 (step 331). The thermal image captured by the thermal camera 31 is input to the thermal image acquisition unit 32. In a case where the marker is warmed or cooled before the processing in step S31, the thermal camera 31 preferably captures a thermal image as soon as possible after the marker is warmed or cooled.

### Thermal Image Acquisition Unit 32

The thermal image acquisition unit 32 acquires the thermal image captured by the thermal camera 31 (step S32). The acquired thermal image is input to the marker detection unit 33.

### Marker Detection Unit 33

The marker detection unit 33 detects a marker by using the thermal image (step S33). A detection result of the marker is output from the marker detection unit 33.

As marker detection processing by the marker detection unit 33, an existing marker detection algorithm can be used. Note that, as the marker detection processing, the marker detection unit 33 may perform step S331 and then detect a marker by the existing marker detection algorithm in steps 8332 and S333 as in the following example.

Hereinafter, an example of the marker detection processing by the marker detection unit 33 will be described. In the following description, V1 and V2 are predetermined values different from each other. For example, V1 is 0 and V2 is 255.

In a case where the marker is warmed before imaging by the thermal camera 31, the marker detection unit 33 sets a pixel value equal to or larger than a threshold Th in a thermal image as V1, whereas, in a case where the marker is cooled before imaging by the thermal camera 31, the marker detection unit 33 sets a pixel value equal to or smaller than a threshold To in the thermal image as V2 and generates a preprocessed thermal image (step S331).

In a case where the marker is warmed by hand before imaging by the thermal camera 31, Th is, for example, 40 °C By the processing in step S331, it is possible to reduce determination errors in processing in step S332 described later.

The marker detection unit 33 binarizes the preprocessed thermal image by using a threshold T and generates a binarized thermal image (step S332). For example, the marker detection unit 33 generates a binarized thermal image by setting a pixel value equal to or larger than the threshold T in the preprocessed thermal image as V2 and a pixel value less than the threshold T as V1.

The marker detection unit 33 determines whether or not an area of a first pixel value (e.g. V1) and a second pixel value (e. g. V2) matching a pre-registered pattern exists in the binarized thermal image. If the area matching the pre-registered pattern exists in the binarized thermal image, the marker detection unit 33 determines that the area matching the pre-registered pattern is a marker corresponding to the pre-registered pattern (step S333).

The marker is detected in this manner, for example.

### Application Example of Marker

As described above, the marker can be imaged by the thermal camera. Further, by appropriately selecting the material of the pattern, the marker can be imaged by a visible light or near-infrared camera. Therefore, the thermal camera and the visible light or near-infrared camera can be aligned by using the same marker. Conversely, as described above, the pattern may be made inconspicuous in the wavelength range of visible light. This makes it possible to use the marker in a situation where the marker is not desired to be conspicuous in designs of furniture, interior, and the like.

### Program, Recording Medium, or the Like

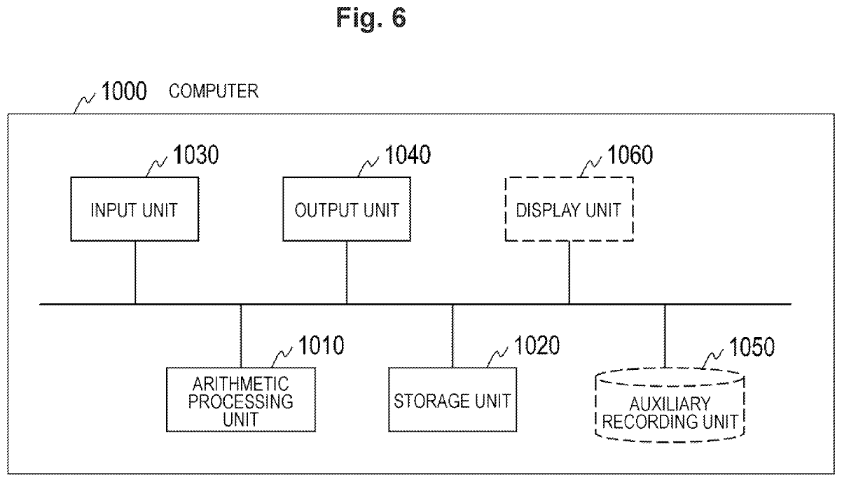

The processing of each unit of the marker detection device 3 may be implemented by a computer. In this case, processing content of functions that the marker detection device 3 should have is written by a program. Then, by causing a storage unit 1020 of a computer 1000 shown in FIG. 6 to read this program and causing an arithmetic processing unit 1010, an input unit 1030, an output unit 1040, a display unit 1060, and the like to operate, various processing functions of the marker detection device 3 are achieved on the computer.

The marker detection device 3 includes, for example, as a single hardware entity, an input unit that can receive input of a signal from the outside of the hardware entity, an output unit that can output a signal to the outside of the hardware entity, a communication unit to which a communication device (for example, a communication cable) capable of communicating with the outside of the hardware entity can be connected, a central processing unit (CPU, which may include a cache memory, a register, and the like) which is an arithmetic processing unit, a random access memory (RAM) and read only memory (ROM) which are memories, an external storage device which is a hard disk, and a bus connected such that the input unit, the output unit, the communication unit, the CPU, the RAM, the ROM, and the external storage device can exchange data. Further, if necessary, a device (drive) or the like that can read and write a recording medium such as a CD-ROM may be provided in the hardware entity. Examples of a physical entity including such a hardware resource include a general-purpose computer.

The external storage device of the hardware entity stores programs required for achieving the above-described functions, data required for processing of the programs, and the like (the programs may be stored, for example, in a ROM as a read-only storage device instead of the external storage device). Further, such data or the like obtained by the processing of the program is appropriately stored in the RAM, the external storage device, or the like.

In the hardware entity, each program stored in the external storage device (or the ROM or the like) and data required for processing of each program are read into a memory as necessary and are appropriately interpreted, executed, and processed by the CPU. As a result, the CPU implements predetermined functions (each of the components represented as . . . unit or the like in the above description). That is, each of the components of the embodiments of the present invention may include processing circuitry.

As described above, in a case where the processing functions of the hardware entity (marker detection device 3) described in the above embodiments are implemented by a computer, processing content of the functions that the hardware entity should have is written by a program. The computer then executes this program, whereby the processing functions of the hardware entity are implemented in the computer.

The program in which the processing content is written can be recorded on a computer-readable recording medium. The computer-readable recording medium is, for example, a non-transitory recording medium and is specifically a magnetic recording device, an optical disc, or the like.

Distribution of the program is performed by, for example, selling, transferring, or renting a portable recording medium such as a DVD or a CD-ROM on which the program is recorded. Further, the program may be stored in a storage device of a server computer, and the program may be distributed by being transferred from the server Computer to another computer via a network.

For example, the computer that executes such a program first temporarily stores the program recorded in the portable recording medium or the program transferred from the server computer in an auxiliary recording unit 1050 that is a non-transitory storage device thereof. Then, at the time of executing processing, the computer reads the program stored in the auxiliary recording unit 1050 serving as the non-transitory storage device thereof into the storage unit 1020 and executes processing according to the read program. Further, as another mode of executing the program, the computer may directly read the program from the portable recording medium into the storage unit 1020 and execute processing according to the program, or, each time the program is transferred from the server computer to the computer, the computer may sequentially execute processing according to the received program. Further, the above-described processing may be executed by a so-called application service provider (ASP) service that implements a processing function only by an execution instruction and result acquisition without transferring the program from the server computer to the computer. Note that the program in the present mode includes information that is used for processing by an electronic computing machine and is equivalent to the program (data or the like that is not a direct command to the computer but has a property that defines processing of the computer).

Further, in this mode, the marker detection device 3 is configured by executing a predetermined program on the computer, but at least part of the processing content may be implemented by hardware.

In addition, it is needless to say that changes can be appropriately made without departing from the gist of this invention.

All documents, patent applications, and technical standards described in this specification are incorporated herein by reference to the same extent as in a case where incorporation by reference of each document, patent application, and technical standard is specifically and individually described.

1. A marker for being captured by a thermal camera for thermal imaging, wherein:
the marker comprises a high-thermal-conductive material;
a surface of the marker indicates a pattern formed by a combination of a first surface area and a second surface area; and
the second surface area indicates a thermal emissivity that is higher than than a thermal emissivity of the first surface area.

2. The marker according to claim 1, wherein
the first surface area of the marker comprises a first partial area,
the second surface area of the marker comprises a second partial area,
the marker comprises a first material and second material respectively made from types of high-thermal conductive materials,
the first material represents a base material continuously extending over the first partial area and the second partial area,
the first partial area comprises a surface of the first material as the first surface area,
the second partial area comprises a combination of the first material and the second material that is formed on the surface of the first material,
the second partial area comprises a surface of the second material as the second surface area, and
the second surface area indicates a light emissivity that is higher than the first surface area.

3. The marker according to claim 1, wherein
the first surface area of the marker comprises a first partial area,
the second surface area of the marker comprises a second partial area,
the marker comprises a first material and second material respectively made from types of high-thermal conductive materials,
the first material represents a base material continuously extending over the first partial area and the second partial area,
the second partial area comprises a surface of the first material as the second surface area,
the first partial area comprises a combination of the first material and the second material formed on the surface of the first material,
the first partial area comprises a surface of the second material as the first surface area, and
the second surface area indicates a light emissivity that is higher than the first surface area.

4. The marker according to claim 1, wherein
the first surface area of the marker comprises a first partial area,
the second surface area of the marker comprises a second partial area,
the marker comprises a base material made from the high-thermal-conductive material continuously extending over the first partial area and the second partial area,
the first surface area and the second surface area respectively comprise a surface of the base material, and
at least either one of the first surface area or the second surface area comprises a surface that has been treated such that the second surface area indicates an emissivity of a light energy that is higher than the first surface area.

5. The marker according to claim 1, wherein the high-thermal-conductive material comprises a material of at least 100 W/mK.

6. The marker according to claim 1, wherein the first surface area comprises a material based on at least one of: blackbody paint, silicon nitride, or carbon graphite.

7. The marker according to claim 1, wherein the second surface area comprises a material based on at least one of: copper, aluminum, zinc, gold, silver, or duralumin.

8. The marker according to claim 1, wherein a temperature of the marker is distinct from a temperature of a surface area surrounding the marker.

9. The marker according to claim 2, wherein a color of the first material is distinct from a color of the second material.

10. The marker according to claim 2, wherein a result of the thermal imaging by the thermal camera distinguishes the first surface area of the marker from the second surface area of the marker based on emissivity of light energy from the marker and reflected heat by the marker.
